(19) United States
(12) Patent Application Publication
(10) Pub. No.: US 2026/0066140 A1
(43) Pub. Date: Mar. 5, 2026

(54) IMPROVEMENTS IN AND RELATING TO TRITIUM EXTRACTION AND RECOVERY IN FUSION POWER SYSTEMS

(71) Applicant: UK ATOMIC ENERGY AUTHORITY, Abingdon, Oxfordshire (GB)

(72) Inventors: Eduardo Garciadiego ORTEGA, Abingdon (GB); Anthony HOLLINGSWORTH, Abingdon (GB)

(73) Assignee: UK ATOMIC ENERGY AUTHORITY, Abingdon, Oxfordshire (GB)

(21) Appl. No.: 19/106,773

(22) PCT Filed: Aug. 18, 2023
(86) PCT No.: PCT/GB2023/052171

§ 371 Date: Feb. 26, 2025

(30) Foreign Application Priority Data
Aug. 26, 2022 (GB) 2212453.1

(51) Int. Cl. G21B 1/11; B01D 61/24; C01B 4/00

(52) U.S. Cl. CPC G21B 1/115; B01D 61/246; C01B 4/00

(57) ABSTRACT

An apparatus and method for integrated tritium extraction and recovery in a fusion power system includes combining-in a tritium extraction unit-a fluid tritium breeding composition with a second fluid to generate a combined fluid undergoing two phase flow, and extracting tritium from the breeding composition in the two-phase flow by simultaneous processes of permeation across a solid membrane and tritium transfer onto the second fluid (i.e., gas-liquid or liquid-liquid contacting).

### FIELD OF THE INVENTION

The present disclosure relates generally to tritium breeding in fusion power systems. More specifically, the disclosure is concerned with an improved tritium extraction and recovery system/apparatus ‘TERS’ for use with liquid breeders.

### BACKGROUND

Currently, fusion reactors which rely on magnetic confinement, principally those designed on the principles of the tokamak, utilise a fusion fuel comprising a mix of deuterium and tritium (i.e., hydrogen isotopes). While deuterium is readily available by, e.g., extraction from seawater, natural Tritium is incredibly rare; current estimates put the quantity of tritium on earth at only 20 kilograms (kg), and the current cost is approximately thirty thousand dollars per gram. DEMO, the demonstration power plant planned as the follow on to ITER, is estimated to require 300 g of tritium a day for continuous power generation. The Spherical Tokamak for Energy Production, STEP, is similarly estimated to require hundreds of grams a day for continuous operation. It is therefore desirable to find techniques for manufacturing tritium for use in fusion reactors.

Interestingly, tritium can be produced from the reaction of neutrons with lithium. Neutrons are, of course, produced by the fusion reactor, and so one technique for tritium production is to coat the reactor in a lithium blanket. Of course, this raises the problem of how to recover the tritium being produced in the blanket for use in the reactor. One approach to tritium extraction is permeation against vacuum, ‘PAV’, whereby tritium is allowed to exit the fluid by transitioning across a hydrogen permeable membrane into a vacuum vessel. Another approach is by gas liquid contactors, GLC, which separate tritium from the liquid breeder by directly contacting the liquid breeder with a gas and the tritium is transferred to the gas phase because a gradient of concentration is formed. Neither approach is particularly efficient; for example, a PAV efficiency between 5-39% is commonly reported, with more recent PAV designs reporting an efficiency of up to 80% tritium recovery.

It is particularly desirable to increase the recovery efficiency as this will allow for a reduction of the tritium inventory in the breeder blanket and associated in-vessel-components (IVCs), and smaller footprint of the TERS. Hence it is desirable to develop improved and/or alternative techniques for tritium breeding with improved recovery efficiencies to provide fuel for fusion systems.

### SUMMARY

The present invention is defined according to the independent claims. Additional features will be appreciated from the dependent claims and the description herein. Any embodiments which are described but which do not fall within the scope of the claims are to be interpreted merely as examples useful for a better understanding of the invention.

The example embodiments have been provided with a view to addressing at least some of the difficulties that are encountered with current approaches to tritium extraction and recovery, whether those difficulties have been specifically mentioned above or will otherwise be appreciated from the discussion herein.

Broadly, the present techniques aim to provide an integrated process whereby tritium extraction is done by permeation and by gas-liquid (or liquid-liquid) contact separation. Advantages of the presently described integrated contactor-permeator include improved efficiency of tritium recovery, reduced tritium residence time in the system thereby allowing for smaller equipment, lower tritium inventory, and ease of compatibility with conventional breeder systems, including similar manufacturing, installation, and maintenance considerations as conventional PAV systems, thereby reducing risks associated with uptake of the technology.

Accordingly, in one aspect of the invention there is provided an apparatus for use in a tritium extraction and recovery of a fusion power system. The apparatus comprises a manifold configured to receive a first fluid of tritium breeding composition and a second fluid, and output a combined fluid undergoing two phase flow; the breeding composition forms the carrier phase of the two-phase flow while the second fluid forms the other phase. The apparatus further comprises a tritium extraction unit configured to receive the combined fluid and extract tritium from the breeding composition within the two-phase flow by a combination of processes: (i) a process of tritium permeation across a hydrogen permeable solid boundary/membrane, and simultaneously (ii) a process of tritium transfer onto the second fluid (i.e., gas liquid, or liquid-liquid contacting). The two-phase flow provides a dual benefit of allowing for the deployment of the two different extraction mechanisms in the same apparatus, while also enhancing performance of the permeation aspect of the tritium extraction.

Preferably the second fluid (such as an inert gas or molten salt) has a higher tritium affinity than the first fluid. In particular, the choice of second fluid may be varied according to the choice of breeding composition. For example, where the tritium breeding composition is formed from pure liquid lithium, the second fluid may be preferably a molten salt such as lithium chloride, and where the tritium breeding composition is formed from lead-lithium liquid metal (PbLi) or a lithium-based molten salt such as FLiBe (a mixture of lithium fluoride (LiF) and beryllium fluoride (BeF₂)), the second fluid may comprise an inert gas, preferably helium.

In one example, the tritium extraction unit is arranged to include a first channel, a second channel, and the hydrogen permeable membrane therebetween (i.e., joining the first and second channel). The first channel is arranged to receive the combined fluid undergoing two phase flow, while the second channel is arranged receive tritium, from the first channel, via the hydrogen permeable membrane; the second channel may be under vacuum pressure or comprise a flow of a sweep gas. In some examples the tritium extraction unit comprises a third channel arranged on an opposite side of the second channel to the first channel, separated from (and joined to) the second channel by hydrogen permeable membrane, the third channel also being arranged to receive combined fluid of breeding composition and second fluid undergoing two-phase flow. Preferably the channels are formed with a planar arrangement, which may be arranged level with the ground when the unit is in use.

In another aspect of the invention there is provided a nuclear fusion power system. The system comprises a vacuum vessel, a tritium breeder blanket (at least partly) surrounding the inside or outside wall of the plasma vacuum vessel which is filled with a fluid tritium breeding composition (such as pure lithium, or PbLi, or FLiBe). The system also comprises a tritium extraction and recovery apparatus comprising a manifold configured to receive the fluid tritium breeding composition and a second fluid to output a combined fluid undergoing two phase flow, and a tritium extraction unit configured to receive the combined fluid and extract tritium from the breeding composition by a combination of tritium permeation across a hydrogen permeable solid boundary/membrane, and simultaneously tritium transfer onto the second fluid. Such a system may also comprise other suitable components, such as a tritium storage unit.

Suitably, in another aspect of the invention there is provided a method of tritium extraction from a fluid tritium breeding composition. The method comprises combining the tritium breeding composition with a second fluid to generate a combined fluid undergoing two phase flow, extracting tritium from the breeding composition within the two-phase flow by simultaneously performing processes of permeation across a hydrogen permeable solid boundary/membrane and tritium transfer onto the second fluid (i.e., gas liquid contacting).

### BRIEF DESCRIPTION OF THE DRAWINGS

For a better understanding of the present disclosure reference will now be made by way of example only to the accompanying drawings, in which:

FIG. 1 shows a process schematic of a fusion power system including an example tritium extraction and recovery process;

FIG. 2 shows an example permeation against vacuum process;

FIG. 3 shows a process schematic of an improved example tritium extraction and recovery system;

FIG. 4 shows an example tritium extraction unit for use in the example tritium extraction and recovery system;

FIG. 5 shows an example two-phase flow and associated tritium distribution;

FIG. 6 shows further example two-phase flows.

### DETAILED DESCRIPTION

At least some of the following example embodiments provide an improved technique for tritium extraction and recovery. Other advantages and improvements may also be apparent from the discussed embodiments herein.

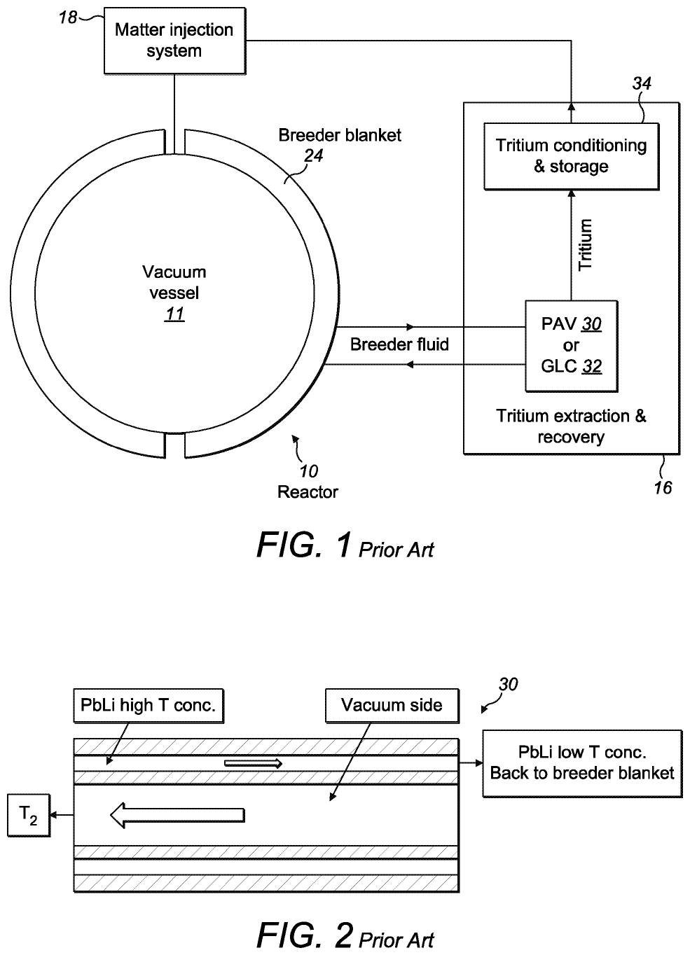

FIG. 1 shows a simplified process schematic of a prior art breeding system. Here, a reactor 10 utilises deuterium and tritium as fusion fuel, the reaction of which produces neutrons. The fusion reaction takes place in the reactor vacuum vessel 11, with the neutrons penetrating the vacuum vessel 11 wall to enter a breeding blanket 24. Fluid comprising tritium/tritiated species (either in the form of coolant or breeder liquid) is pumped from the blanket 24 so that tritium can be extracted by a suitable tritium extraction and recovery system 16. The extraction and recovery system 16 comprises a unit to extract tritium from the breeder fluid, either a permeator against vacuum unit 30 or a gas-liquid contactor 32, and means to condition and store the tritium 34. Sometime later, the recovered tritium is cycled from the storage 34 into the reactor by a suitable matter injection system 18.

By way of example, FIG. 2 shows an example of a conventional permeator against vacuum ‘PAV’ unit 30. The unit 30 comprises a channel for carrying liquid breeder (e.g., lithium lead, PbLi) which is rich with tritium (which has come from the breeder blanket 24), and a vacuum channel which is separated from the liquid breeder by a membrane through which tritium can pass. The breeder liquid which enters at the left hand side of the PAV in FIG. 2 becomes depleted of tritium as it passes left to right and the tritium permeates into the vacuum channel. The liquid breeder now with low concentration of tritium is pumped back to the breeder blanket 24 to once again breed tritium from neutron interaction.

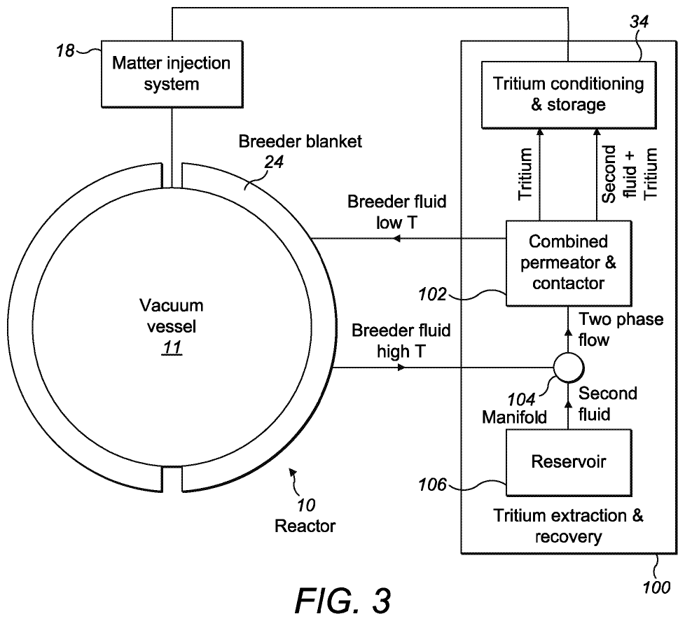

FIG. 3 shows a process schematic for an improved technique for tritium extraction and recovery in a fusion power system in which an example improved tritium extraction and recovery apparatus (or system) 100 is utilised. Notably, the apparatus 100 comprises a tritium extraction unit 102 configured to perform tritium extraction on breeder composition fed to the unit 102 by processes of permeation and gas-liquid (or liquid-liquid) contacting simultaneously. That is, the tritium extraction unit utilises permeation of tritium through a solid to extract tritium from the breeding composition, similar to known PAVs, while also facilitating tritium transfer to the second fluid phase because a gradient of concentration is formed between the breeder composition and second fluid.

The apparatus 100 suitably comprises a manifold 104 which feeds fluid to the tritium extraction unit 102. More specifically, the manifold 104 is configured to receive a first fluid of tritium breeding composition from the breeding blanket 24, and also receive a second fluid from e.g., a reservoir 106 (although it will be appreciated that the exact source of the second fluid may be varied). The tritium breeding composition may be at least one of a lithium-based salt, a lithium-based liquid metal, or a lithium-based alloy, while the second fluid may be at least one of an inert gas or a lithium-based salt (where that's not also the first fluid).

The manifold 104 is configured to combine the two fluids into a two-phase flow in which the first fluid/breeder composition forms a carrier phase, and the second fluid forms the other, second, phase. In the example shown, the manifold is configured to combine the fluids prior to supply to the tritium extraction unit 102 to undergo initial tritium extraction. In another example, however (not shown), the manifold may be arranged within the tritium extraction unit 102 (in such a case the description of the tritium extraction unit 102 below thereby applying to the part of the tritium extraction unit 102 after the manifold 104).

As the combined fluid progresses through the tritium extraction unit 102, at least some of the tritium is extracted from the first phase (i.e., the breeder composition) by a process of permeation and suitably recovered, in this example by routing to a conditioning and storage unit 34. Also, at least some of the tritium is extracted from the first phase/breeder composition by transfer onto the second phase fluid, which is suitably recovered after the two-phase fluid has exited the tritium extraction unit 102 and after separating the combined fluid back into the two separate fluids. That is, the separated fluid breeder composition is returned to the breeder blanket 24 for tritium generation (i.e., closing the breeder fluid loop), while the separated second fluid (rich in tritium) is routed for further processing to recover the tritium for later use. Specific means for separating the breeding composition from the second fluid, and subsequently recovering the tritium from the second fluid, will be readily appreciated by those in the art of gas liquid contacting; for example, the tritium recovery from the second fluid may be incorporated as part of conditioning and storage unit 34.

It will also be appreciated that, in some example arrangements, the extracted tritium may not require storage and may instead be suitably routed directly back into the reactor by e.g., the matter injection system 18. Similarly, it is not required for tritium extracted by permeation and tritium extracted from the second fluid to follow the same ultimate route to storage/reactor (though it is preferred for simplicity of construction and maintenance, etc); for example, tritium extracted by permeation may be suitable for direct recycling into the reactor 10, while tritium extracted by transfer to the second fluid may be more appropriate for storage.

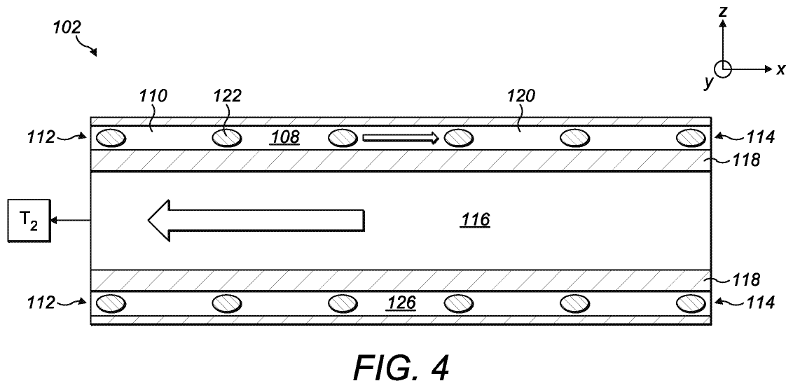

FIG. 4 shows the example tritium extraction unit 102 in more detail. The tritium extraction unit 102 comprises a first channel 108 arranged to receive the combined fluid 110 undergoing two phase flow; here demonstrated by the fluid being predominantly tritium breeding composition 120 in which are interspersed bubbles of second fluid, such as helium, 122 (although other inert gasses could also be used as the second fluid, such as Argon). The channel 108 carries the combined fluid 110 from a first end 112 of the unit 102 to a second end 114 of the unit 102; that is, the first end 112 may be considered a fluid input side of the unit 102, and the second end 114 a fluid output side of the unit 102. In this example, the combined fluid 110 flows left to right from the input 112 to the output 114, and may be induced to do so by a suitably configured pump; other means for moving the combined fluid 110 through the apparatus 100 may also be employed.

The tritium extraction unit 102 also comprises a second channel 116 which is separated from the first channel 108 by a hydrogen permeable membrane 118. A material for the hydrogen permeable membrane 118 is suitably chosen for a combination of bulk strength (to keep the first fluid in the channel 108, and support the structure of the tritium extraction unit 102) and tritium permeability. It will also be appreciated that although the first channel 108, second channel 116, and hydrogen permeable membrane 118 are described here as separate entities, in practice the channels may be considered to be at least partly (or wholly) formed by the hydrogen permeable membrane—i.e., the membrane 118 may be considered as forming at least part of a superstructure, or body, for the tritium extraction unit 102 which defines corresponding channels within it).

Suitably, the second channel 116 is provided to receive tritium which permeates across the membrane 118 from the first channel. In this way, the tritium breeding composition 120 which is rich in tritium at the input 112 (i.e., having come directly from the breeder blanket 24) is at least partly depleted of tritium as it passes through the tritium extraction unit 102. Some tritium, however, becomes absorbed by the second fluid bubbles 122. Thus, the combined fluid which exits the tritium extraction unit 102 may be considered to be formed from tritium breeder composition comprising a low concentration of tritium, and a combination of helium-tritium gas (which will be appreciated by those in the art as being highly suitably for tritium extraction by suitable subsequent separation processes). For this reason, it is preferable (though not essential) for the second fluid 122 to have a higher tritium affinity than the breeding composition 120. In particular, where the wherein the tritium breeding composition 120 is formed from pure liquid lithium, the second fluid may be a molten salt (such as lithium chloride, a mixture of lithium and sodium or potassium chlorides, or a lithium carbonate), while where the tritium breeding composition 120 is formed from lead-lithium or FLiBe, the second fluid may be an inert gas such as helium.

The two-phase flow not only allows for the deployment of the two different extraction mechanisms in the same apparatus 100, but also has benefits for the performance of the permeation aspects of the tritium extraction unit 102.

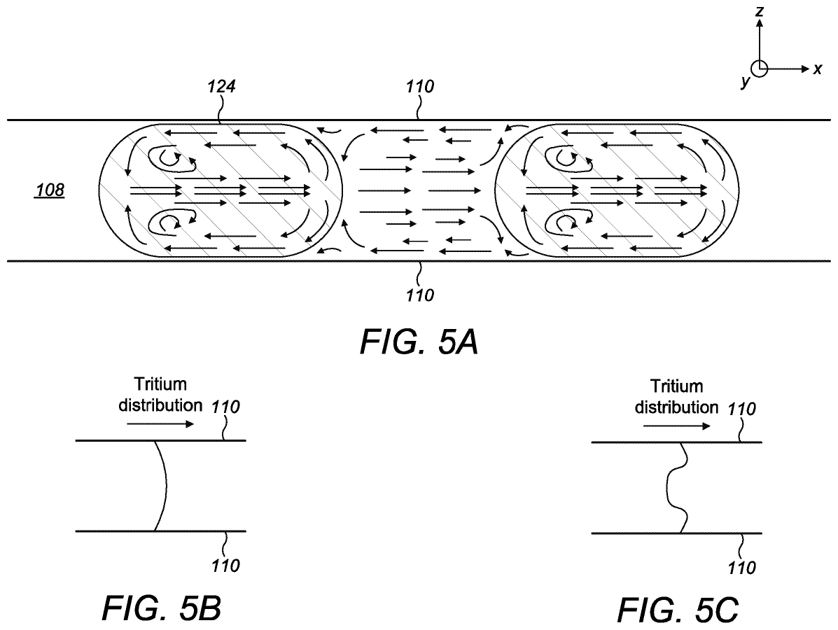

FIG. 5 demonstrates these benefits in the case of an idealised Taylor (two-phase) flow within the first channel 108. FIG. 5A shows the fluid dynamics of the tritium breeder composition 120 and the helium bubbles 122; FIG. 5B shows the tritium distribution for a channel undergoing single phase flow; FIG. 5C shows the tritium distribution for the example of FIG. 5A.

In a single-phase flow of breeder composition, the tritium to be extracted would be interspersed randomly, albeit substantially evenly, throughout a cross section of the fluid. Tritium which is close to a hydrogen permeable membrane 118 may permeate out very quickly based on its proximity, while the bulk of the tritium, which is towards the centre of the channel 108, would take significantly longer to progress along the concentration gradient. Hence the tritium concentration at any given time follows a distribution (FIG. 5B) with more tritium at the centre of the channel.

By contrast, in the case of two-phase flow, the bubbles 122 help generate a thin film of breeder composition 120 against the permeation membrane along the sections where the bubbles are (e.g., at section 124), which puts tritium closer to the membrane 118 and therefore more likely to permeate across the boundary. Also, the fluid dynamics between carrier (breeder) fluid 120 and the bubbles 122 change the flow patterns sufficiently that the tritium starts to stagnate off the axis of the channel, and so closer to the side surfaces (i.e., the permeable membranes), such that the tritium concentration profile may look instead like FIG. 5C. Thus, the rate of tritium permeation from the composition 120 in between concurrent bubbles 122 is also increased.

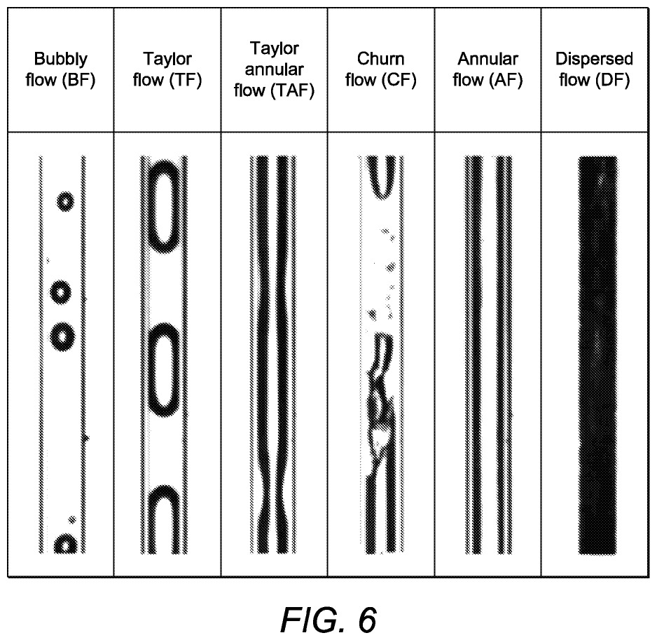

Although FIG. 5 shows a preferred example two-phase flow, similar benefits may also be realised from other forms of two-phase flow (to a generally lesser extent), such as those shown in FIG. 6. In other words, while it is preferable that the manifold and flow parameters of the first/second fluid inflows are configured to generate a Taylor-flow, this is not essential.

Returning to FIG. 4, in one example the second channel 116 is maintained at a vacuum (negative) pressure, in order to impart a flow direction to the tritium permeating into the channel; here the direction is shown as right to left, although the direction is not important and the choice will depend on physical device considerations when it is in use. In this way the apparatus 100 may more readily be used as a replacement device for fusion systems which currently utilise known PAV technology (and so already have suitable vacuum equipment ready to be connected to the tritium extraction unit 102). In another example, the second channel 116 is at least partly filled with a sweep gas, such as helium, the flow of which aids in flushing tritium through and out of the tritium extraction unit 102 where it can then be separated from the sweep gas. The benefit of utilising a sweep gas is that helium (or other) gas compressors and corresponding piping are generally cheaper to purchase, install, and operate compared to vacuum systems. In either case, tritium which permeates into the second channel may be suitably recovered. In some examples the sweep gas includes very small amounts of an additive such as Oxygen to help the tritium later desorb from the membrane surface.

As shown, in this example the first channel 108 and second channel 116 are configured to run parallel to each other along substantially the length (x direction, left/right) of the tritium extraction unit 102. Likewise, the hydrogen permeable membrane 118 provides a shared boundary between the first channel 108 and second 116 along substantially the entire length of the tritium extraction unit 102. Such an arrangement provides increased surface area by which tritium can permeate out of the fluid in the first channel 108.

Moving to three dimensions, more generally the first channel 108 and second channel 116 are preferably provided in a planar arrangement. That is, each of the first and second channel define parallel planes in the x (left/right) and y (in/out of page) directions. Again, this parallel planar arrangement provides greater surface area for tritium permeation. Further preferably, the tritium extraction unit 102 in this arrangement should be installed horizontal to the ground (i.e., perpendicular to the direction of gravity), to avoid causing any unnecessary pumping strain on the fluid that might otherwise arise from e.g., gravity acting on the fluid 110.

Continuing the present example, the tritium extraction unit 102 may also be considered to comprise a third channel 126 arranged on an opposite side of the second channel 116 to the first channel 108; the second and third channels similarly being separated by hydrogen permeable membrane 118. The third channel also receives the combined fluid 112, such that in this arrangement provides yet further surface area for tritium to permeate into the second channel 116 across a hydrogen permeable membrane 118. Suitably the manifold 104 may be adapted to feed combined fluid to both first and third channels, or each channel may be provided with separate manifolds by which they are fed with combined fluid.

In some examples this principle may be continued further, with the tritium extraction unit 102 being configured with a stacked arrangement in which combined fluid carrying channels alternate with tritium extracting channels. That is, a fourth channel may be configured to abut the third channel on its opposite side to the second channel, and a fifth channel configured to abut the fourth channel on the opposite side of the fourth channel to the third channel, and so on, each of the channels being essentially abutting but separated by hydrogen permeable membrane, with odd numbered channels being combined fluid carrying channels, and even numbered channels tritium extraction channels. Or, put another way, the first and second channels 108, 116 may be considered to define a blueprint for a single stack in the stacked arrangement, with a plurality of stacks formed from pairs of first and second channels being arranged on top of the third channel 126 which in this case may be considered as a lower most, or base, channel of the tritium extraction unit 102. Also, while the above description assumes that a combined fluid carrying channel will be the outer most channel of the stack (i.e., top and bottom), it be will be appreciated that the arrangement could be modified to have tritium extraction channels as the outermost channels while still achieving substantially the same functionality.

Dimensions of the first, second, and where appropriate third, channels 108, 116, 126 may be determined based on the desired flow rate of fluid/gas through the different channels. For example, for integration of the present apparatus with the breeder blanket designs for the DEMO power plant, it has been determined that a width of the first/third channel 108 (or each such channel in a stack) in the z direction of 0.5 centimetres (cm) to 2 cm, inclusive, produces a particularly beneficial two-phase flow. Simulations have also shown that suitable tritium extraction efficiencies of over 80% (i.e., greater than previously obtainable efficiencies) may be achieved with a channel length of around 5 metres (m), which is significantly shorter than many other PAV systems, thereby reducing the overall profile of the required apparatus and corresponding space required in a power plant. In some examples, simulations have shown efficiencies of between 85%-95% for a suitably optimised apparatus.

In summary, exemplary embodiments of an improved apparatus for tritium extraction and recovery have been described. The apparatus comprises a manifold and a tritium extraction unit. The manifold is configured to combine a tritium breeding composition with a second fluid to create a combined fluid undergoing two phase flow. The tritium extraction unit receives the combined fluid to simultaneously extract tritium from the breeding composition by tritium permeation across a solid membrane and tritium transfer to the second fluid.

The described exemplary embodiments enable more efficient improved fusion power techniques that facilitates continuous operation of the reactor: an important consideration for commercial energy production. Moreover, the exemplary embodiments reduce the energy requirements for tritium production associated with existing breeder blankets, and also allow for a reduction in onsite tritium inventory.

The example apparatus may be manufactured industrially. An industrial application of the example embodiments will be clear from the discussion herein. Additionally, the described exemplary embodiments are convenient to manufacture and straightforward to use.

Although preferred embodiment(s) of the present invention have been shown and described, it will be appreciated by those skilled in the art that changes may be made without departing from the scope of the invention as defined in the claims and as described above. For example, although repeated reference herein has been made to channel, it will be appreciated by those in the art that channel extends to other forms of (enclosed) fluid paths such as tubes, conduits, and the like, and is not intended to impart a particular geometry except where stated for a particular example.

Attention is directed to all papers and documents which are filed concurrently with or previous to this specification in connection with this application and which are open to public inspection with this specification, and the contents of all such papers and documents are incorporated herein by reference.

All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification, or to any novel one, or any novel combination, of the steps of any method or process so disclosed.

1. An apparatus for use in tritium extraction and recovery in a fusion power system, comprising:
a manifold configured to receive a first fluid comprising a tritium breeding composition and a second fluid, and output a combined fluid undergoing two phase flow wherein the first fluid is a first, carrier, phase of the two-phase flow and the second fluid is a second phase of the two-phase flow;
a tritium extraction unit configured to receive the combined fluid and extract tritium from the tritium breeding composition by a combination of tritium permeation across a hydrogen permeable membrane and tritium transfer onto the second fluid.

2. The apparatus of claim 1, wherein the second fluid comprises at least one of an inert gas and a molten salt.

3. The apparatus of claim 1, wherein the second fluid has a higher tritium affinity than the first fluid.

4. The apparatus of claim 2, wherein the tritium breeding composition is formed from pure liquid lithium, and the second fluid comprises the molten salt.

5. The apparatus of claim 4, wherein the molten salt comprises at least one or a combination of a lithium chloride, a lithium sodium chloride, a lithium potassium chloride, or lithium carbonate.

6. The apparatus of claim 2, wherein the tritium breeding composition is formed from a lithium based molten salt, or a lithium-based eutectic alloy, and the second fluid comprises the inert gas, for example helium.

7. The apparatus of claim 6, wherein the lithium based molten salt is one of PbLi or FLiBe.

8. The apparatus of claim 1, wherein the tritium extraction unit comprises a first channel, a second channel, and the hydrogen permeable membrane therebetween, wherein the first channel is arranged to receive the combined fluid undergoing two phase flow, and the second channel is arranged receive tritium, from the first channel, via the hydrogen permeable membrane.

9. The apparatus of claim 8, wherein the first channel and second channel are planar in arrangement.

10. The apparatus of claim 9, wherein the planar arrangement is perpendicular to gravity.

11. The apparatus of claim 8, wherein the tritium extraction unit comprises a third channel arranged on an opposite side of the second channel to the first channel, and a second hydrogen permeable membrane between the second and third channels, the third channel also being arranged to receive combined fluid undergoing two-phase flow and the second channel also being arranged to receive tritium from the third channel via the second hydrogen permeable membrane.

12. The apparatus of claim 1, wherein the second channel supports a flow of a sweep gas.

13. The apparatus of claim 12, wherein the sweep gas comprises helium.

14. A nuclear fusion power system, comprising:
a vacuum vessel;
a tritium breeder blanket at least partly surrounding the vacuum vessel and comprising a fluid tritium breeding composition:
a manifold configured to receive the fluid tritium breeding composition and a second fluid, and output a combined fluid undergoing two phase flow wherein the fluid tritium breeding composition is a first, carrier, phase of the two-phase flow and the second fluid is a second phase of the two-phase flow;
a tritium extraction unit configured to receive the combined fluid undergoing two-phase flow and extract tritium from the breeding composition by a combination of tritium permeation across a hydrogen permeable membrane and tritium transfer onto the second fluid.

15. A method of tritium extraction from a fluid tritium breeding composition, the method comprising:
combining the fluid tritium breeding composition with a second fluid to generate a combined fluid undergoing two phase flow, wherein the fluid tritium breeding composition is a first, carrier, phase of the two-phase flow and the second fluid is a second phase of the two-phase flow;
extracting at least some tritium from the breeding composition in the two-phase flow by a process of tritium permeation across a hydrogen permeable membrane, and simultaneously extracting at least some tritium from the breeding composition in the two-phase flow by a process of tritium transfer onto the second fluid.
